(19) United States
(12) Patent Application Publication
(10) Pub. No.: US 2003/0048850 A1
(43) Pub. Date: Mar. 13, 2003

(54) Composite video decoding

(76) Inventor: Michel Wouter Nieuwenhuizen, Eindhoven (NL)

Correspondence Address: U.S. Philips Corporation, 580 White Plains Road, Tarrytown, NY, 10591, US

(21) Appl. No.: 10/237,816

(22) Filed: Sep. 9, 2002

(30) Foreign Application Priority Data
Sep. 11, 2001 (EP) 01203420.3

(51) Int. Cl. H04N 7/12

(52) U.S. Cl. 375/240.25; 348/527

(57) ABSTRACT

Television uses a composite video signal to transmit color information. A color signal filter (12, 16) selects one of a plurality of candidate color signals derived from the composite video signal. The plurality comprises a first and second difference signal between the information for a central line and for lines on a first side and a second side of the central line respectively. The color signal filter promotes selection of the first difference signal over the second difference signal and vice versa according to whether the composite video signal represents an image with an edge on the second or first side of the central line respectively at the horizontal position. The apparatus contains circuitry (14) to detect a thin line configuration where data from the composite video signal for the central line is extreme relative to corresponding data for first and second lines on the first and second side respectively at the horizontal position. This circuitry (14) is coupled to the color signal filter (12, 16) to command selection of the information from the central line when the thin line configuration is detected.

The invention relates to a television apparatus and a composite video decoding method and device for use in such an apparatus.

A television signal is generally supplied as a composite video signal that contains luminance information and color information mixed with each other. Composite video signals are defined for example in the NTSC and PAL standards. In the composite video signal the color information has been added to the upper part of the frequency spectrum of the luminance signal, modulated onto a sub-carrier. To isolate the color signal from the composite video signal various techniques are known.

A well-known technique is to use an intermediate signal obtained by subtracting composite signal values that are delayed a number of image lines from one another. This is based on the fact that the modulated color signal is added to the luminance with different polarity in different image lines of a television field. This is the case for example in NTSC and PAL signals. To describe this, the notion of “conjugate” lines will be used. If the polarity with which color added to the luminance in a first line is opposite to that polarity in a second line, the first and second line will be called conjugate lines. In an NTSC signal successive lines are conjugate. In a PAL pairs of lines that are delayed two lines with respect to one another are conjugate. Assuming that the luminance information does not change between two conjugate lines that are near to each other, subtraction of the composite video signals for the conjugate lines will eliminate the luminance information, but not the color information. Thus, the color information can be isolated from the composite video signal. However, this leads to errors when the luminance signal changes appreciably from line to line, such as at points in the image where the image content has edges between different visible objects.

Various techniques have been developed to reduce such errors. When the image content includes an edge between two visible objects, these techniques try to ensure that the color signal will be derived by subtracting the composite video signal of conjugate lines that are on the same side of the edge. This reduces errors due to strong variations in luminance signal.

In U.S. Pat. No. 5,394,193, for example a number of difference signals is determined by subtracting signals from different conjugate lines from a current line. At the same time, the difference between the low frequency parts of the current line and each of the conjugate lines is determined. The difference represents the correlation between different lines. The signal from the current line minus that of the conjugate line that has the lowest low frequency difference in luminance is used to obtain the color signal.

U.S. Pat. No. 5,355,177 describes a different type of technique, in which the median of a number of signals is used to derive the color signal. This technique depends on the combination of signals from which the median is determined. This combination contains for example subtracted signals wherein different conjugate lines have been subtracted from the current line, the current line and the inverse of signals that have been subtracted from the current line. In case of an edge, the median of this combination is the subtracted signal in which the line that is on the same side of the current line is subtracted from the current line.

However, it has been found that these techniques still show errors in the neighborhood of thin line content in the image represented by the composite video signal.

Amongst others it is an object of the invention to provide a composite video decoding in which the quality of color decoding is improved.

On aspect of the invention provides for a television apparatus comprising

a connection for receiving lines of a composite video signal;

a color signal filter arranged to select for output one of a plurality of candidate color signals derived from information obtained from the composite video signal for a horizontal position, the plurality comprising a first and second difference signal between the information for a central line and for lines on a first side and a second side of the central line respectively, the color signal filter being arranged to promote selection of the first difference signal over the second difference signal and vice versa according to whether the composite video signal represents an image with an edge on the second or first side of the central line respectively at the horizontal position;

configuration detection circuitry arranged to detect a thin line configuration where data from the composite video signal for the central line is extreme relative to corresponding data for first and second lines on the first and second side respectively at the horizontal position, the configuration selection circuitry being coupled to the color signal filter to command selection of the information from the central line when configuration detection circuitry detects the thin line configuration.

When a thin line is detected in the image represented by the composite video signal (because of an extreme data value at the central line, i.e. lower or higher than the data values for the surrounding lines), the use of differences between information for different image lines to obtain the color signal is suppressed. When no thin line is detected any suitable technique for obtaining the color signal may be used, preferably using difference signals between information from different lines on one side of an edge, in case of an edge. Thus, color-decoding artifacts caused by thin lines in the image are reduced.

Preferably, a low frequency luminance part of the composite video signal is used as data to detect the thin line, whereas a band pass filtered part of the composite video signal is used as information to generate the color signal. This makes the most efficient use of dynamic signal range. However, without deviating from the invention, the composite video signal itself may be used as this information and/or data. Preferably, the lines of which the data is used to detect the thin line are the same lines that are used to obtain the difference signals. This reduces the amount of different data and information needed to a minimum. However, without deviating from the invention other lines, or combinations thereof, may be used.

Preferably, the suppression of the use of difference signals in case of thin lines is gradual, a mixture of a difference signal and the information from the central line being used if the data for the central line, although extreme, does not differ much from that for the surrounding line, the information for the central line being used if the data for the central line differs more than a threshold value from that for the surrounding lines. Thus, artifacts due to suppression of the difference signal are reduced.

An additional advantage of the invention is that in an embodiment it can be added to conventional techniques that suppress the effect of edges, like techniques that used medians, with the addition of very little hardware, because the invention mostly uses components that are already needed for these conventional techniques.

These and other object and advantageous aspects of the apparatus according to the invention will become apparent from the following description.

In the drawings,

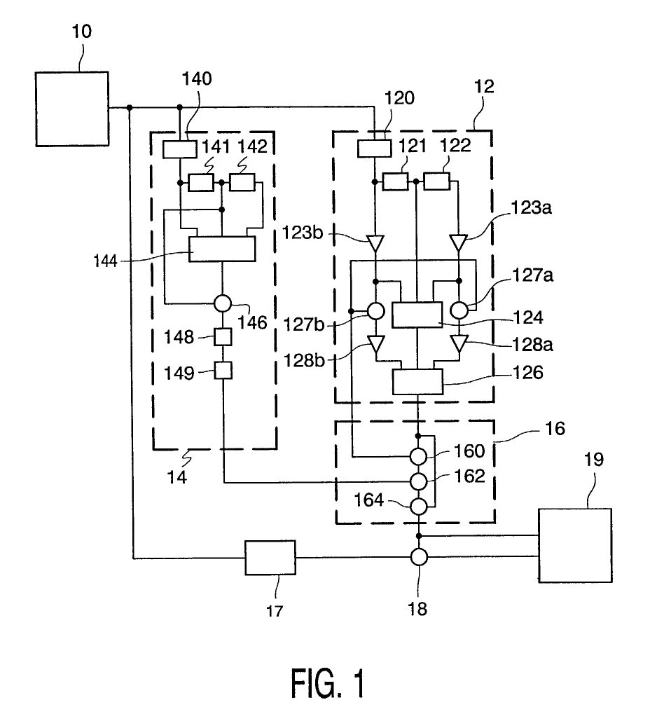

FIG. 1 shows a television apparatus;

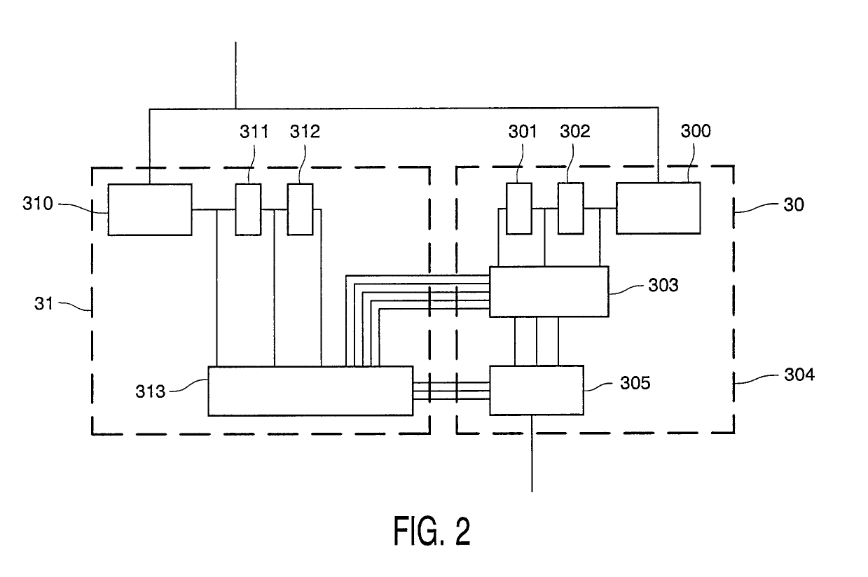

FIG. 2 shows a color decoder; and

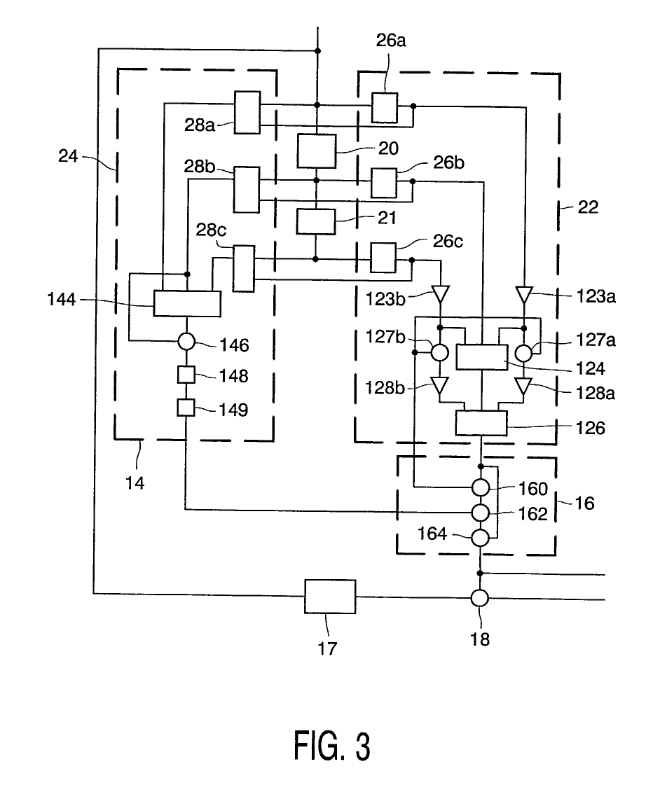

FIG. 3 shows part of a line content detector.

FIG. 1 shows a television apparatus. The apparatus contains a receiver 10, a color signal generator 12, a line content detector 14, a selector 16, a main delay circuit 17, a subtractor 18 and a display system 19. The receiver 10 has an output 11 for a composite video signal. The output 11 is coupled to inputs of the color signal generator 12, the line content detector 14 and the main delay circuit 17 respectively. The color signal generator 12 has two outputs coupled to inputs of the selector 16. The line content detector 14 has an output coupled to a control input of the selector 16. The selector 16 has an output coupled to an input of the display system 19 and to an input of the subtractor 18. The color signal generator 12 and the selector 16 together form a color signal filter that produces a color signal demodulated from a composite video signal received from the receiver. Main delay circuit 17 provides a delay of one image line in case of an NTSC system and two image lines in case of a PAL system. Main delay circuit 17 has an output coupled to subtractor 18. Subtractor 18 has an output for a demodulated luminance signal coupled to the display system 19.

In operation, receiver 10 forms a composite video signal, for example by demodulating a broadcast signal, or by retrieval from a storage device (not shown). Color signal generator 12, line content detector 14, selector 16, main delay circuit 17 and subtractor 18 serve to extract a luminance signal and a color signal from the composite video signal and to supply these signals to display system 19. Display system 19 displays the image represented by the luminance and color signal and performs further processing of these signals as necessary for display. Although a display system 19 is shown, it will be understood that without deviating from the invention, this system 19 may be replaced with any other kind of system, such as for example a storage system or an image recognition system.

FIG. 1 shows an example of a color signal generator 12, which contains a band pass filter 120, a first and second delay circuit 121, 122, inverters 123a,b, a first median filter 124, averaging units 125a,b and a second median filter 126. Delay circuits 121, 122 each provide a delay of one image line in case of an NTSC system and two image lines in case of a PAL system. The band pass filter 120 receives the composite video signal and passes a band passed filtered version of this signal (suppressing low frequency luminance components that do not spectrally overlap color components of the composite video signal) in three ways to the first median filter 124 (1) via the first inverter 123a, (2) via first delay circuit 121 and (3) via a cascade of the delay circuits 121, 122 and the second inverter 123b. Instead of a band-pass filter, a high pass filter may be used if the composite video signal from receiver 10 has no higher frequency content. Second median filter 126 receives its inputs from the first median filter 124 and from the inverters 123a, b, each via a respective one of the averaging circuits 125a,b. The averaging circuits are shown to contain an adder 127a,b and a halving unit 128a,b. The outputs of the color signal generator 12 are coupled to the out output of the second median filter 126 and to the input for the composite video signal, via the first delay line 121.

Line content detector 14 comprises a low pass filter 140, a first and second delay circuit 141, 142, a median filter 144, a subtractor 146, a rectifier 148 and a clipping unit 149. Low pass filter 140 filters out color components from the composite video signal and the part of the luminance signal that spectrally overlaps these components. Delay circuits 141, 142 each provide a delay of one image line in case of an NTSC system and two image lines in case of a PAL system. The input of the low pass filter 140 receives the composite video signal. The output of the low pass filter is coupled three times to the respective inputs of the median filter 144: (1) directly, (2) via the first delay circuit 141 and (3) via a cascade of the first and second delay circuit 141, 142. The subtractor 146 has inputs coupled the output of the median filter 144 and to the output of the low-pass filter 140, the latter via first delay circuit 141. The output of the subtractor 146 is coupled to the control input of selector 16 via the rectifier 148 and the clipping unit 149 successively.

Selector 16 contains a subtractor 160, a multiplier 162 and an adder 164. The inputs of subtractor 160 are coupled to the outputs of the color signal generator 12. The inputs of the multiplier 162 are coupled to the outputs of the subtractor 160 and the line content detector 14. The inputs of the adder 164 are coupled to the output of the second median filter in color signal generator 14 and to the output of adder 164. The output of adder 164 forms the output of selector 16.

In operation, the color signal generator 12 produces a main output signal and an auxiliary output signal, which are used by selector 16 to form a color signal. The main output signal is a median filtered output signal, which has been filtered so as to remove the luminance component from the output of the band pass filter 120. The structure of color signal generator 12 ensures that the luminance component has been removed as best as possible even if there is an edge between visible objects in the image represented by the composite video signal. The color signal generator 12 uses signals from three image lines, obtained at the input of the first delay circuit 121 and at the outputs of the first and second delay circuit respectively. If the signal from the central line and a first line on the side of the central line encode similar color and luminance from one object and the signal from the second line on the side of the central line encodes a different color and luminance from the other side of the object, the color signal generator outputs the a half times the difference between the signal of the central line and the first line on the side. In case of a “ramp” (a constant rate of change) in the color and luminance signals from one line to another, the color signal generator outputs the signal from the central line. In this way, the effect on color decoding of fast luminance changes near edges is minimized.

The structure of the color signal generator unit 12 is only one example how this result may be achieved: many other structures known and possible structures, such as other median filters, or correlation based filters may be used to remove the luminance component as best as possible, even if there is an edge between visible objects in the image.

Problems arise when the composite video signal represents an image content that includes a thin line, on which the content differs from the content on either side of the thin line, the color signal generator 12 produces errors. Thin lines occur for example in mosaic image that is made up of sub-images separated by thin lines. To distinguish these “thin lines” in the content of the image clearly from the image (scanning) lines with which a television builds up an image, the words “thin line” will consistently be used. In case of a thin line that determines the composite signal for the central line, but not the signals of the neighboring line the color signal generator 12 typically outputs half the difference of the signals of the central line and one of the neighboring lines. This is not the way to produce the least error when the color signal is extracted: it would have been better to use the signal for the central line, that is a band pass filtered version of the composite video signal, delayed by the first delay circuit 121. This error is characteristic of many different possible implementations of the color signal generator 12, not just for the one shown in FIG. 1.

Correction of this error is corrected is improved by the use of line content detector 14 and selector 16. Line content detector 14 is selectively responsive to thin lines. It produces a signal that becomes stronger when the low frequency content of the luminance signal has a local extreme (maximum or minimum) as a function of position in vertical direction in the image.

In the example shown in FIG. 1 this is realized by working with values of the low frequency content for corresponding image position from three image lines. (It will be appreciated that, although a separate low-pass filter 140, a low-pass filter may also be approximated by subtracting the output of the band-pass filter 120 from it input, since high frequencies other than that in the band do not disturb the detector). The median of the values in the three different image lines is subtracted from the value the central one of these lines. If the central one of the lines has the median value, the output of the line content detector 14 will be zero. However, if the median is unequal to the value for the central line, then this value will be an extreme among the three values, which indicative of a thin line in the image content. In this case, the output of the rectifier 148 is proportional to the difference between the value for the central one of the lines and the closest value from the other lines. The clipping unit 149 outputs a control signal in proportion to the output of the rectifier 148, limited to a saturation value.

Selector 16 uses the output of the line content detector 14 to control alpha channeling between the two output signals of the color signal generator 12. At zero control signal selector 16 passes the main output signal of color signal generator 12. At the saturation value of the control signal, selector 16 passes an auxiliary signal, which is the band-pass filtered signal for the central line from first delay circuit 121. Thus if the central line not extreme (in the absence of a thin line) selector 16 passes the main output signal as color signal. If the central line extreme (thin line), the auxiliary output signal is output, possibly mixed (alpha channeled) with the main output if the difference between the central line and at least one of the other lines is not very large.

FIG. 2 shows a more general circuit for extracting the color signal. This circuit contains a color signal filter 30 and a detector 31. The color signal filter 30 contains a band pass (or high pass) filter 300, first and second delay circuit 301, 302 signal combination circuit 303, and multiplexer 305. The band-pass filter 30 has an input that receives the composite video signal and an output that is coupled to the combination circuit 303 directly, via first delay circuit 301 and via a cascade of first and second delay circuit 301, 302.

Detector 31 contains a low pass filter 310, delay circuits 311, 312 and configuration detector 313. The low pass filter 30 has an input that receives the composite video signal and an output that is coupled to the configuration detector 313 directly, via first delay circuit 311 and via a cascade of first and second delay circuit 311, 312. Configuration detector 313 has further inputs coupled to outputs of combination circuit 303. Configuration detector 313 has outputs coupled to control inputs of multiplexer 305, which has an output coupled to the output of the color signal generator.

In operation, signal combination circuit 303 generally operates linearly and forms a number of linear combinations of its input signals that may be used as color signal under different circumstances. For example, it forms differences between signals from adjacent conjugate lines, one or more signals from individual lines etc. By way of example outputs for three such signals are shown, but fewer or more may be used.

Configuration detector 313 detects which of the output signals of combination circuit 303 should be used. It produces a selection signal for multiplexer 305 to select that signal. For example, if configuration detector 313 detects an edge, it selects a difference signal between the signals on two conjugate lines on one side of the edge is used. If configuration detector 31 detects a thin line, the signal from a single line is selected. It will be understood that configuration detector 31 may detect such configurations in any possible way, for example by comparing the low pass filtered signals for three pixels on vertically adjacent lines only (as was the case in FIG. 1), or by considering the signals for rows of horizontally adjacent pixels on these lines etc. Also it may use the band pass filtered signals instead of, or in combination with the low pass filtered signals to detect specific configurations in order to form a corresponding selection signal. Multiplexer 305 may be an on/off multiplexer, which passes either one signal or another (or no signal at all), or an alpha channeled multiplexer, which switches from one input to another gradually, dependent on the strength of the selection signals from configuration detector 313, in the same way as selector 16 of FIG. 1.

It will be appreciated that various changes can be made to the circuits without deviating from the invention. For example, the sequence of the delay circuits and the filters may be changed, which makes it possible to reduce the number of delay circuits that is needed.

FIG. 3 shows an embodiment of a part of the circuit according to the invention. In this embodiment delay circuits 20, 21 are shared by a color signal generator 22 and a line content detector 24. Band-pass filtering is performed with separate filters 26a-c behind the delay circuits and low-pass filters are realized by subtracting the output of the band-pass filters from their input, using subtractors 28a-c. In this embodiment, most of the components are components used in any case when median filtering is used to determine the color signal. The modification of the color signal if line content is detected requires very little additional components (notably subtractors 28a-c, median filter 144, subtractor 146, rectifier 148, clipping unit 149, subtractor 160, multiplier 162 and adder 164).

In each of the embodiments the color signal generator, the line content detector and the selector 16 are preferably integrated together in an integrated circuit for processing composite video signals.

It will be appreciated that the apparatus is not limited to the described embodiments. For instance, any alternative multi-line color signal generator may be used, such as other median based filters or filters based on the detection of correlation between image lines. Other methods of detecting local extremes may be used in the line content detector 14. Instead of the gradual alpha-channeling of selector 16, digital switching may be used using a multiplexer. Inverted or factored signals may be used (for example by inserting an inverter at the central input of first median filter 124, and omitting inverters 123a,b), the averaging may be realized in different ways etc.

Also the function of the various circuits 12, 14, 16 may be merged, for example by performing the selection function through the adaptation of the input signals before they are supplied to the first and second median filters 124, 126.

It should thus be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

List of reference numerals and their meaning:

| | |
|---|---|
| 10 | receiver |
| 11 | output |
| 12 | color signal generator |
| 14 | line content detector |
| 16 | selector |
| 17 | delay circuit |
| 18 | subtractor |
| 19 | display system |
| 20, 21 | delay circuits |
| 22 | color signal generator |
| 24 | line content detector |
| 26a | filters |
| 28a | subtractors |
| 30 | filter |
| 31 | detector |
| 120 | filter |
| 121, 122 | first and second delay circuits |
| 123b | second inverter |
| 123a | first inverter |
| 124, 126 | first and second median filters |
| 124 | first median filter |
| 125a | averaging circuits |
| 126 | median filter |
| 127a | adder |
| 128a | halving unit |
| 140 | filter |
| 141, 142 | first and second delay circuits |
| 144 | median filter |
| 146 | subtractor |
| 148 | rectifier |
| 149 | clipping unit |
| 160 | subtractor |
| 162 | multiplier |
| 164 | adder |
| 300 | filter |
| 301, 302 | first and second delay circuits |
| 303 | combination circuit |
| 305 | multiplexer |
| 310 | low pass filter |
| 311, 312 | first and second delay circuits |
| 313 | detector |

1. A composite video decoder comprising:
a connection (10) for receiving lines of a composite video signal;
a color signal filter (12, 16) for selecting for output one of a plurality of candidate color signals derived from information obtained from the composite video signal for a horizontal position, the plurality comprising a first and second difference signal between the information for a central line and for lines on a first side and a second side of the central line respectively, the color signal filter being arranged to promote selection of the first difference signal over the second difference signal and vice versa according to whether the composite video signal represents an image with an edge on the second or first side of the central line respectively at the horizontal position; and
configuration detection circuitry (14) for detecting a thin line configuration where data from the composite video signal for the central line is extreme relative to corresponding data for first and second lines on the first and second side respectively at the horizontal position, the configuration selection circuitry being coupled to the color signal filter to command selection of the information from the central line when configuration detection circuitry detects the thin line configuration.

2. A composite video decoder to claim 1, the configuration detection circuitry (14) being arranged to generate a detection signal representative of a degree of difference between the data for the central line and first and/or second line when the data for the central line is extreme, the color signal filter (12, 16) comprising a mixing unit (16) controlled by the detection signal, so as to fade from the first or second difference signal to the information for the central line increasingly when the degree of difference is larger.

3. A composite video decoder according to claim 2, wherein the configuration detection circuitry (14) comprises:
a low-pass filter (140) for determining a luminance part of the composite video signal substantially excluding color information;
a median filter (144) for determining a median of the luminance part for the central line, the first line and the second line; and
a detector (146, 148, 149) for detecting whether the median differs from the luminance part for the central line, an output of the detector being fed to the color signal filter for commanding selection.

4. A composite video decoder according to claim 3, comprising delay circuits (20, 21) for obtaining mutually delayed version of the composite video signal for the central line and the first and second line from a common input, and to supply said signals both to the configuration detection circuit (14) and the color signal filter (12, 16), for performing thin line detection and for forming the candidate output signal respectively.

5. A television apparatus comprising:
the composite video decoder (12, 14, 16) of claim 1; and
a display system (19) for displaying an output of the composite video decoder.

6. A composite video decoding method comprising:
receiving (10) lines of a composite video signal;
selecting (12, 16) for output one of a plurality of candidate color signals derived from information obtained from the composite video signal for a horizontal position, the plurality comprising a first and second difference signal between the information for a central line and for lines on a first side and a second side of the central line respectively;
promoting selection of the first difference signal over the second difference signal and vice versa according to whether the composite video signal represents an image with an edge on the second or first side of the central line respectively at the horizontal position;
detecting (14) a thin line configuration where data from the composite video signal for the central line is extreme relative to corresponding data for first and second lines on the first and second side respectively at the horizontal position; and
commanding selection (12, 16) of the information from the central line when the thin line configuration is detected.
